(19) United States
(12) Patent Application Publication
(10) Pub. No.: US 2021/0023912 A1
(43) Pub. Date: Jan. 28, 2021

(54) TRANSPORTATION RETRIGERATION SYSTEM

(71) Applicant: Carrier Corporation, Palm Beach Gardens, FL (US)

(72) Inventor: Chad Kosakowski, Palm Beach Gardens, FL (US)

(21) Appl. No.: 17/045,955

(22) PCT Filed: Feb. 26, 2019
(86) PCT No.: PCT/US2019/019529

§ 371 Date: Oct. 7, 2020

Related U.S. Application Data
(60) Provisional application No. 62/657,299, filed on Apr. 13, 2018.

(51) Int. Cl. B60H 1/32

(52) U.S. Cl. CPC B60H 1/3232; B60H 2001/00185

(57) ABSTRACT

A transportation refrigeration system includes a refrigeration circuit that includes a compressor and a heat rejection heat exchanger. At least one expansion device and at least one heat absorption heat exchanger is included. A first cooling air outlet is downstream of the at least one heat absorption heat exchanger. A second cooling air outlet is downstream of at least one heat absorption heat exchanger. The first cooling air outlet is spaced from the second cooling air outlet.

### CROSS-REFERENCE TO RELATED APPLICATIONS

This application claims priority to U.S. Provisional Application No. 62/657,299, which was filed on Apr. 13, 2018 and is incorporated herein by reference.

### BACKGROUND

This application relates to refrigeration systems used in cargo spaces having a dividing wall.

Refrigeration systems are known. Generally, a compressor compresses a refrigerant and delivers it into a condenser. The refrigerant is cooled and passes through an expansion valve. The refrigerant is expanded and passes through an evaporator. The evaporator cools air to be delivered into an environment to be conditioned.

One application for such refrigeration systems is in a transportation refrigeration system. As an example, a truck may have a refrigerated trailer. It is known to provide distinct temperatures at distinct compartments within a common trailer. Individual refrigeration circuits are often utilized to provide the distinct temperatures.

### SUMMARY

In one exemplary embodiment, a transportation refrigeration system includes a refrigeration circuit that includes a compressor and a heat rejection heat exchanger. At least one expansion device and at least one heat absorption heat exchanger is included. A first cooling air outlet is downstream of the at least one heat absorption heat exchanger. A second cooling air outlet is downstream of at least one heat absorption heat exchanger. The first cooling air outlet is spaced from the second cooling air outlet.

In a further embodiment of any of the above, a dividing wall contact surface separates the first cooling air outlet from the second cooling air outlet.

In a further embodiment of any of the above, a bulkhead is adjacent the refrigeration circuit. The dividing wall contact surface is located on the bulkhead.

In a further embodiment of any of the above, the first cooling air outlet is located in a first lateral half of the bulkhead and the second cooling air outlet is located in a second lateral half of the bulkhead.

In a further embodiment of any of the above, the first cooling air outlet is spaced at least ten (10) inches from the second cooling air outlet.

In a further embodiment of any of the above, the first cooling air outlet is spaced no more than twelve (12) inches from the second cooling air outlet.

In a further embodiment of any of the above, at least one heat absorption heat exchanger includes a first heat absorption heat exchanger located in a first cooling passageway.

In a further embodiment of any of the above, the first cooling passageway includes a first cooling air inlet that is in fluid communication with the first heat absorption heat exchanger and the first cooling air outlet.

In a further embodiment of any of the above, the first cooling passageway includes a first nozzle that is in fluid communication with a first fan and the first cooling air outlet.

In a further embodiment of any of the above, at least one heat absorption heat exchanger includes a second heat absorption heat exchanger that is located in a second cooling passageway.

In a further embodiment of any of the above, the second cooling passageway includes a second cooling air inlet that is in fluid communication with the second heat absorption heat exchanger and the second cooling air outlet.

In a further embodiment of any of the above, the second cooling passageway includes a second nozzle that is in fluid communication with a second fan and the second cooling air outlet.

In a further embodiment of any of the above, a nozzle is in fluid communication with a fan, the first cooling air outlet and the second cooling air outlet.

In another exemplary embodiment, a method of operating a refrigeration cycle includes the steps of conditioning a first compartment in a cargo space by directing a first portion of a cooling air out of a first cooling air outlet and into the first compartment. A second compartment in the cargo space is conditioned by directing a second portion of the cooling air out of a second cooling air outlet and into the second compartment. The first cooling air outlet is spaced from the second cooling air outlet.

In a further embodiment of any of the above, the method includes separating the first compartment from the second compartment with a dividing wall. The first cooling air outlet is separated from the second cooling air outlet with a dividing wall contact surface.

In a further embodiment of any of the above, a bulkhead is adjacent the first cooling air outlet and the second cooling air outlet. The dividing wall contact surface is located on the bulkhead.

In a further embodiment of any of the above, the first cooling air outlet is spaced at least ten (10) inches from the second cooling air outlet.

In a further embodiment of any of the above, the first cooling air outlet is spaced no more than twelve (12) inches from the second cooling air outlet.

In a further embodiment of any of the above, the method includes adjusting a dividing wall in the cargo space along a dividing wall contact surface located between the first cooling air outlet and the second cooling air outlet.

In a further embodiment of any of the above, the first portion of the cooling air passes through a first cooling air passageway that has a first cooling air inlet that is in fluid communication with a first heat absorption heat exchanger. The first cooling air outlet and the second portion of the cooling fluid passes through a second cooling fluid passageway that has a second cooling fluid inlet that is in fluid communication with a second heat absorption heat exchanger and the second cooling air outlet.

### BRIEF DESCRIPTION OF THE DRAWINGS

FIG. 1 is a schematic view illustrating a prior art refrigeration system in a cargo space.

FIG. 2 is a schematic view illustrating the prior art refrigeration system of FIG. 1 with a dividing wall.

FIG. 3 is a schematic view illustrating a transport refrigeration system according to one example.

FIG. 4 is a schematic view of the air flow for the transport refrigeration system of FIG. 3.

FIG. 5 is a schematic view illustrating the transport refrigeration system of FIG. 3 with a dividing wall.

FIG. 6 is a schematic view illustrating a transport refrigeration system according to another example.

FIG. 7 is a schematic view of the air flow for the transport refrigeration system of FIG. 6.

FIG. 8 is a schematic view illustrating the transport refrigeration system of FIG. 6 with a dividing wall.

### DETAILED DESCRIPTION

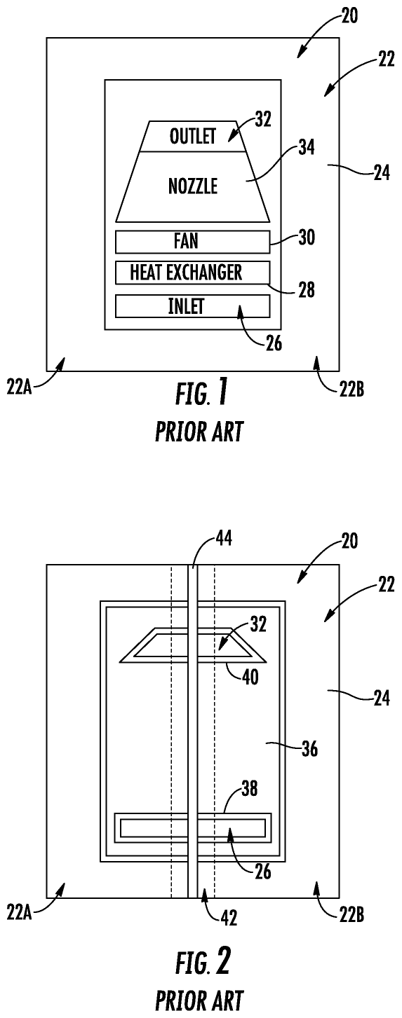

FIG. 1 is a schematic view illustrating a prior art refrigeration system 20 associated with a cargo space 22. The refrigeration system 20 is located in a forward wall 24 of the cargo space 22. The refrigeration system includes an inlet 26 that directs air from the cargo space 22 past a heat absorption heat exchanger 28 to remove heat from the cargo space 22. The air from the cargo space 22 is drawn into the inlet 26 by a fan 30. The fan 30 then directs the air from the cargo space 22 into a nozzle 34 that feeds the air through an outlet 32 and back into the cargo space 22.

As shown in FIG. 2, the prior art refrigeration system 20 is at least partially covered by a bulkhead 36 when used in the cargo space 22. The bulkhead 36 includes an inlet opening 38 that corresponds to the inlet 26 and an outlet opening 40 that corresponds to the outlet 32. When a dividing wall 44 is used to separate the cargo space 22 into a first compartment 22A and a second compartment 22B, the dividing wall 44 partially covers the outlet 32. During use of the cargo space 22 to transport goods, it may be necessary to make adjustments to the location of the dividing wall 44 to create more floor space in either first or second compartments 22A, 22B. The dividing wall 44 can be moved laterally anywhere in a dividing wall area 42. The dividing wall area 42 is generally 2-4 times the width of the dividing wall 44 and is at least partially defined by the dashed line in FIG. 2. The dividing wall area 42 defines the area where the dividing wall 44 contacts at least the bulkhead 36 or the forward wall 24

When the dividing wall 44 is moved laterally in the dividing wall area 42, one of the first and second compartments 22A, 22B will receive a greater amount of cooling because the portion of the outlet 32 corresponding to that compartment will be larger. Conversely, when the dividing wall 44 is moved, the other of the first and second compartments 22A, 22B will receive a smaller amount of cooling because a portion of the outlet 32 corresponding to the other of the first and second compartments 22A, 22B will be smaller. The variation in cooling can become problematic when trying to maintain a specific temperature for each of the first and second compartments 22A, 22B.

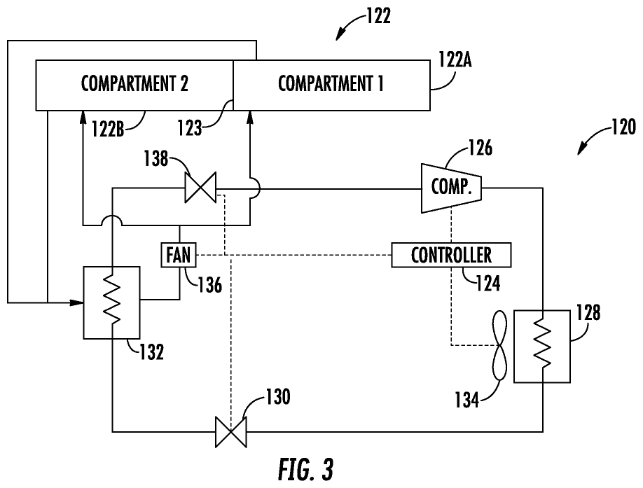

FIG. 3 illustrates a transport refrigeration system 120 associated with a cargo space 122, such as a refrigerated cargo space, according to one example of this disclosure. In the illustrated example, the cargo space 122 is divided into a first compartment 122A and a second compartment 122B by a dividing wall 123.

A controller 124 manages operation of the refrigeration system 120 to establish and regulate a desired product storage temperature within the first compartment 122A and the second compartment 122B of the cargo space 122. The cargo space 122 may be the cargo box of a trailer, a truck, a seaboard shipping container or an intermodal container wherein perishable cargo, such as, for example, produce, meat, poultry, fish, dairy products, cut flowers, and other fresh or frozen perishable products, is stowed for transport.

The refrigeration system 120 includes a refrigerant compression device 126, a refrigerant heat rejection heat exchanger 128, a first expansion device 130, a first refrigerant heat absorption heat exchanger 132, and an outlet valve 138 connected in a closed loop refrigerant circuit and arranged in a conventional refrigeration cycle. The first expansion device 130 can be electrically controlled expansion valve controlled by the controller 124 to regulator refrigerant flow through the first heat absorption heat exchangers 132. The refrigeration system 120 also includes one or more fans 134 associated with the heat rejection heat exchanger 128 and a first fan 136 associated with the first heat absorption heat exchangers 132. In one example, the first heat absorption heat exchanger 132 is an evaporator.

It is to be understood that other components (not shown) may be incorporated into the refrigerant circuit as desired, including for example, but not limited to, a suction modulation valve, a receiver, a filter/dryer, an economizer circuit.

The heat rejection heat exchanger 128 may, for example, comprise one or more refrigerant conveying coiled tubes or one or more tube banks formed of a plurality of refrigerant conveying tubes extending between respective inlet and outlet manifolds. The fan(s) 134 are operative to pass air, typically ambient air, across the tubes of the refrigerant heat rejection heat exchanger 128 to cool refrigerant vapor passing through the tubes.

The first heat absorption heat exchanger 132 may, for example, also comprise one or more refrigerant conveying coiled tubes or one or more tube banks formed of a plurality of refrigerant conveying tubes extending between respective inlet and outlet manifolds. The first fan 136 is operative to pass air drawn from the temperature controlled cargo space 122 across the tubes of the heat absorption heat exchanger 132 to heat the refrigerant passing through the tubes and cool the air. The air cooled in traversing the heat absorption heat exchanger 132 is supplied back to the first and second compartments 122A, 122B in the cargo space 122.

Prior to entering the refrigerant compression device 126, the refrigerant passes through the outlet valve 138. The outlet valve 138 controls a pressure and state of the refrigerant entering the refrigerant compression device 126. The refrigerant compression device 126 may comprise a single-stage or multiple-stage compressor such as, for example, a reciprocating compressor or a scroll compressor.

In the refrigeration system 120, the controller 124 is configured for controlling operation of the refrigeration system 120 including, but not limited to, operation of the various components of the refrigeration system 120 to provide and maintain a desired operating temperature within the cargo space 122. The controller 124 may be an electronic controller including a microprocessor and an associated memory bank. The controller 124 controls operation of various components of the refrigeration system 120, such as the refrigerant compression device 126, the first expansion device 130, the fans 134, 136, and the outlet valve 138.

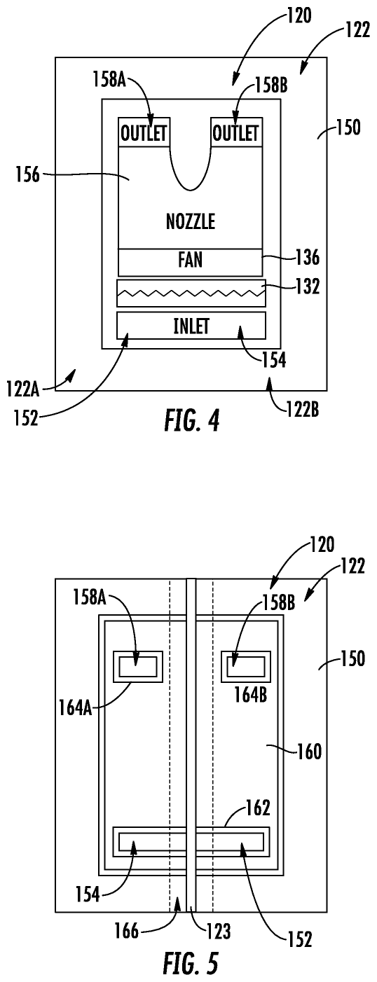

FIG. 4 schematically illustrates the refrigeration system 120 located adjacent a forward wall 150 of the cargo space 122. Although the refrigeration system 120 is located in the forward wall 150 in the illustrated example, the refrigeration system 120 could be located in another wall of the cargo space 22, such as the ceiling. Air from one of the first or second compartments 122A, 122B enters a cooling passageway 152 through an inlet 154 and past a first heat absorption heat exchanger 132. The air from the cargo space 122 is drawn into the inlet 154 by the first fan 136. The first fan 136 then directs the air from the cargo space 122 into a nozzle 156 that feeds the air through a first cooling air outlet 158A and a second cooling air outlet 158B into a respective first and second compartments 122A, 122B of the cargo space 122.

FIG. 5 illustrates a bulkhead 160 enclosing the refrigeration system 120 in the forward wall 150 of the cargo space 122. The bulk head 160 includes an inlet opening 162 corresponding to the inlet 154 to the cooling passageway 152 and a pair of outlet openings 164A, 164B corresponding to the first and second cooling air outlets 158A, 158B.

The first and second cooling air outlets 158A, 158B are separated by a dividing wall contact surface 166. In the illustrated example, dividing wall contact surface 166 is located on the bulkhead 160 and the forward wall 150. However, the dividing wall contact surface 166 could be located on another structure located between the first and second cooling air outlets 158A, 158B. The dividing wall 123 moves laterally along the dividing wall contact surface 166 to accommodate for more or less floor space in the first compartment 122A or the second compartment 122B. In the illustrated example, the dividing wall contact surface 166 is between two and four times the width of the dividing wall 123. Because the first and second cooling air outlets 158A, 158B are spaced from each other, the dividing wall 123 can move laterally along the dividing wall contact surface 166 without interfering with or partially covering either of the first and second cooling air outlets 158A, 158B.

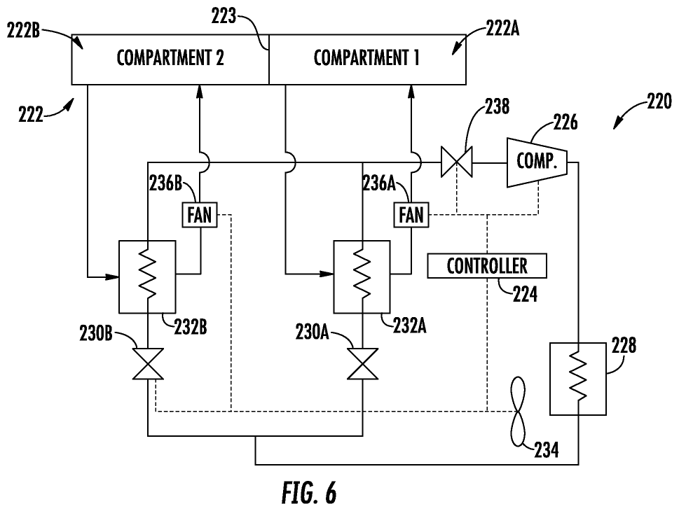

FIG. 6 illustrates a transport refrigeration system 220 associated with a cargo space 222, such as a refrigerated cargo space, according to another example of this disclosure. In the illustrated example, the cargo space 222 is divided into a first compartment 222A and a second compartment 222B by a dividing wall 223.

A controller 224 manages operation of the refrigeration system 220 to establish and regulate a desired product storage temperature within the first compartment 222A and the second compartment 222B of the cargo space 222. The cargo space 222 may be the cargo box of a trailer, a truck, a seaboard shipping container or an intermodal container wherein perishable cargo, such as, for example, produce, meat, poultry, fish, dairy products, cut flowers, and other fresh or frozen perishable products, is stowed for transport.

The refrigeration system 220 includes a refrigerant compression device 226, a refrigerant heat rejection heat exchanger 228, a first expansion device 230A, a second expansion device 230B, a first refrigerant heat absorption heat exchanger 232A, and a second refrigerant heat absorption heat exchanger 232B connected in a closed loop refrigerant circuit and arranged in a conventional refrigeration cycle. The first and second expansion devices 230A, 230B can be electrically controlled expansion valves controlled by the controller 224 to regulator refrigerant flow through each of the first and second heat absorption heat exchangers 232A, 232B, respectively. The refrigeration system 220 also includes one or more fans 234 associated with the heat rejection exchanger 228 and a first and second fan 236A, 236B associated with each of the first and second heat absorption heat exchangers 232A, 232B. In one example, the first and second heat absorption heat exchangers 232A, 232B are evaporators.

It is to be understood that other components (not shown) may be incorporated into the refrigerant circuit as desired, including for example, but not limited to, a suction modulation valve, a receiver, a filter/dryer, an economizer circuit.

The heat rejection heat exchanger 228 may, for example, comprise one or more refrigerant conveying coiled tubes or one or more tube banks formed of a plurality of refrigerant conveying tubes extending between respective inlet and outlet manifolds. The fan(s) 234 are operative to pass air, typically ambient air, across the tubes of the refrigerant heat rejection heat exchanger 228 to cool refrigerant vapor passing through the tubes.

The first and second heat absorption heat exchangers 232A, 232B may, for example, also comprise one or more refrigerant conveying coiled tubes or one or more tube banks formed of a plurality of refrigerant conveying tubes extending between respective inlet and outlet manifolds. The first and second fans 236A, 236B are operative to pass air drawn from the temperature controlled cargo space 222 across the tubes of the heat absorption heat exchangers 232A, 232B to heat the refrigerant passing through the tubes and cool the air. The air cooled in traversing the heat absorption heat exchangers 232A, 232B is supplied back to a respective first and second compartments 222A, 222B in the cargo space 222.

Prior to entering the refrigerant compression device 226, the refrigerant passes through an outlet valve 238. The outlet valve 238 controls a pressure and state of the refrigerant entering the refrigerant compression device 226. The refrigerant compression device 226 may comprise a single-stage or multiple-stage compressor such as, for example, a reciprocating compressor or a scroll compressor.

In the refrigeration system 220, the controller 224 is configured for controlling operation of the refrigeration system 220 including, but not limited to, operation of the various components of the refrigeration system 220 to provide and maintain a desired operating temperature within the cargo space 222. The controller 224 may be an electronic controller including a microprocessor and an associated memory bank. The controller 224 controls operation of various components of the refrigeration system 220, such as the refrigerant compression device 226, the first and second expansion devices 230A, 230B, the fans 234, 236A, 236B, and the outlet valve 238.

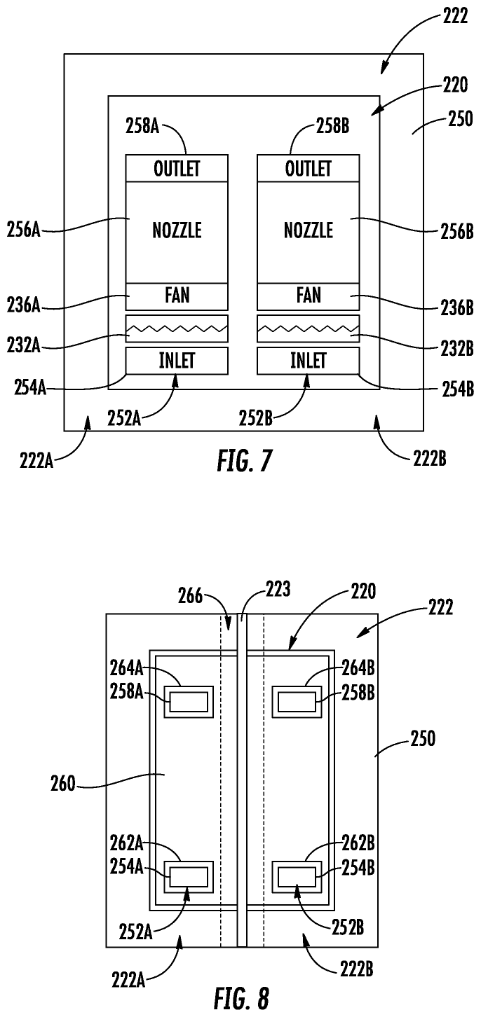

FIG. 7 schematically illustrates the refrigeration system 220 located adjacent a forward wall 250 of the cargo space 222. Although the refrigeration system 220 is located in the forward wall 250 in the illustrated example, the refrigeration system 220 could be located in another wall of the cargo space 222, such as the ceiling. Air from the first and second compartments 222A, 222B enters a first and second cooling passageway 252A, 252B through a first and second inlet 254A, 254B and past the first and second heat absorption heat exchangers 232A, 232B, respectively. The air from the first and second compartments 222A, 222B is drawn into the first and second inlets 254A, 254B by the first and second fans 236A, 236B. The first and second fans 236A, 236B then directs the air from the first and second compartments 222A, 222B into a first and second nozzle 256A, 256B that feeds the air through a first and second cooling air outlet 258A, 258B into the first and second compartments 222A, 222B of the cargo space 222, respectively.

FIG. 8 illustrates a bulkhead 260 enclosing the refrigeration system 220 in the forward wall 250 of the cargo space 222. The bulk head 260 includes first and second inlet openings 262A, 262B corresponding to the first and second inlets 254A, 254B to the first and second cooling passageways 252A, 252B, respectively, and first and second of outlet openings 264A, 264B corresponding to the first and second cooling air outlets 258A, 258B.

The first and second cooling air outlets 258A, 258B are separated by the dividing wall contact surface 266. In the illustrated example, dividing wall contact surface 266 is located on the bulkhead 260 or the forward wall 250. However, the dividing wall contact surface 266 could be located on another structure located between the first and second cooling air outlets 258A, 258B. The dividing wall 223 moves laterally along the dividing wall contact surface 266 to accommodate for more or less floor space in the first and second compartment 222A, 222B. In the illustrated example, the dividing wall contact surface 266 is between two and four times the width of the dividing wall 223. Because the first and second cooling air outlets 258A, 258B are spaced from each other, the dividing wall 223 can move laterally along the dividing wall contact surface 266 without interfering with or partially covering either of the first and second cooling air outlets 258A, 258B.

Although the different non-limiting embodiments are illustrated as having specific components, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should also be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claim should be studied to determine the true scope and content of this disclosure.

What is claimed is:

1. A transportation refrigeration system comprising:
a refrigeration circuit including a compressor, a heat rejection heat exchanger, at least one expansion device, at least one heat absorption heat exchanger;
a first cooling air outlet downstream of the at least one heat absorption heat exchanger; and
a second cooling air outlet downstream of the at least one heat absorption heat exchanger, wherein the first cooling air outlet is spaced from the second cooling air outlet.

2. The transportation refrigeration system of claim 1, further comprising a dividing wall contact surface separating the first cooling air outlet from the second cooling air outlet.

3. The transportation refrigeration system of claim 2, further comprising a bulkhead adjacent the refrigeration circuit and the dividing wall contact surface is located on the bulkhead.

4. The transportation refrigeration system of claim 3, wherein the first cooling air outlet is located in a first lateral half of the bulkhead and the second cooling air outlet is located in a second lateral half of the bulkhead.

5. The transportation refrigeration system of claim 2, wherein the first cooling air outlet is spaced at least ten (10) inches from the second cooling air outlet.

6. The transportation refrigeration system of claim 5, wherein the first cooling air outlet is spaced no more than twelve (12) inches from the second cooling air outlet.

7. The transportation refrigeration system of claim 2, wherein the at least one heat absorption heat exchanger includes a first heat absorption heat exchanger located in a first cooling passageway.

8. The transportation refrigeration system of claim 7, wherein the first cooling passageway includes a first cooling air inlet in fluid communication with the first heat absorption heat exchanger and the first cooling air outlet.

9. The transportation refrigeration system of claim 8, wherein the first cooling passageway includes a first nozzle in fluid communication with a first fan and the first cooling air outlet.

10. The transportation refrigeration system of claim 7, wherein the at least one heat absorption heat exchanger includes a second heat absorption heat exchanger located in a second cooling passageway.

11. The transportation refrigeration system of claim 10, wherein the second cooling passageway includes a second cooling air inlet in fluid communication with the second heat absorption heat exchanger and the second cooling air outlet.

12. The transportation refrigeration system of claim 11, wherein the second cooling passageway includes a second nozzle in fluid communication with a second fan and the second cooling air outlet.

13. The transportation refrigeration system of claim 2, further comprising a nozzle in fluid communication with a fan, the first cooling air outlet, and the second cooling air outlet.

14. A method of operating a refrigeration cycle comprising the steps of:
conditioning a first compartment in a cargo space by directing a first portion of a cooling air out of a first cooling air outlet and into the first compartment; and
conditioning a second compartment in the cargo space by directing a second portion of the cooling air out of a second cooling air outlet and into the second compartment, wherein the first cooling air outlet is spaced from the second cooling air outlet.

15. The method of claim 14, further comprising:
separating the first compartment from the second compartment with a dividing wall and separating the first cooling air outlet from the second cooling air outlet with a dividing wall contact surface.

16. The method of claim 15, further comprising a bulkhead adjacent the first cooling air outlet and the second cooling air outlet and the dividing wall contact surface is located on the bulkhead.

17. The method of claim 15, wherein the first cooling air outlet is spaced at least ten (10) inches from the second cooling air outlet.

18. The transportation refrigeration system of claim 5, wherein the first cooling air outlet is spaced no more than twelve (12) inches from the second cooling air outlet.

19. The method of claim 15 further comprising:
adjusting a dividing wall in the cargo space along a dividing wall contact surface located between the first cooling air outlet and the second cooling air outlet.

20. The method of claim 15, wherein the first portion of the cooling air passes through a first cooling air passageway having a first cooling air inlet in fluid communication with a first heat absorption heat exchanger and the first cooling air outlet and the second portion of the cooling fluid passes through a second cooling fluid passageway having a second cooling fluid inlet in fluid communication with a second heat absorption heat exchanger and the second cooling air outlet.
